(19) United States
(12) Patent Application Publication
(10) Pub. No.: US 2022/0309545 A1
(43) Pub. Date: Sep. 29, 2022

(54) METHOD FOR DISPLAYING ADVERTISEMENTS IN A BROWSER AND/OR IN AN APP

(71) Applicants: Albert Luntsch, Trumau (AT); Gerald Schaller, Brunn am Gebirge (AT)

(72) Inventor: Albert LUNTSCH, Trumau (AT)

(73) Assignees: Albert LUNTSCH, Trumau (AT); Gerald SCHALLER, Brunn am Gebirge (AT)

(21) Appl. No.: 17/638,432

(22) PCT Filed: Aug. 15, 2020
(86) PCT No.: PCT/AT2020/060307

§ 371 Date: Feb. 25, 2022

(30) Foreign Application Priority Data
Aug. 30, 2019 (AT) A50753/2019

(51) Int. Cl. G06Q 30/02

(52) U.S. Cl. CPC G06Q 30/0277; G06Q 30/0251

(57) ABSTRACT

A method for displaying advertisements in a browser, in which a software or an app of the browser is installed on an electronic medium, and the browser is shown on a screen or display, respectively, when the software or app is activated. The browser is used to search the interne and/or intranet for so-called content, and the results are displayed or listed, respectively, in a display area of the browser. A function bar with an input field is displayed on the browser above the display area. When a search query is made or a result activated in the display area, or when an internet page is directly invoked by the browser, a database is concomitantly queried for stored advertisements which are related to defined criteria and/or the content. If an advertisement is stored and found, this advertisement is displayed in the browser independently of or as a function of the internet page or web page, respectively, called up.

The invention relates to a method for displaying advertisements in a browser as well as to a method for displaying advertisements in an app, as described in claims 1 and 11.

Among other things, the Internet is used as a platform for displaying advertisements. Various options for displaying advertisements via web applications are known in the art, for example search-engine advertising, such as Google Ads on the Google search engine, or advertising directly on store platforms, such as amazon.de, or web pages of individual companies.

Here, the disadvantage is that in the case of store platforms or web pages, respectively, the user or Internet surfer, respectively, must find this page and, when searching in search engines such as Google Ads, advertisements are often ignored or not in the focus of the user, who usually wants to find a specific result with a search.

Consequently, companies or sellers, respectively, in turn use a variety of other platforms or methods, such as social media, e.g. weblogs, forums, social networks, wikis and podcasts, etc., to network their web content accordingly and bring their advertising and products to the user or buyer, respectively. The disadvantage here is likewise that the advertising content must first be found by the user or buyer, respectively, who is interested in the advertised product. With the plethora of options, it is also becoming increasingly difficult for sellers to filter out which media the potential buyer group is using or where on the Internet they are surfing, respectively. In addition, maintenance of data and advertisements on the multitude of differing platforms is very time-consuming and complex. Moreover, an objective evaluation of the advertising expenditure made becomes virtually impossible.

This is why in many cases advertising companies are commissioned that, with the appropriate expertise, are able to use, link and evaluate the multitude of advertising media in order to reach numerous users or potential buyers, respectively, with the advertising. The disadvantage of this is that such advertising professionals now represent a separate industry whose services are expensive. In addition, it is difficult for the seller to understand whether the evaluations of the advertising companies are indeed objective, especially since they evaluate their own services at the same time. Here the advertising company acts as a link or interface between sellers and buyers or between supply and demand, respectively. This way is still the most effective option, but at the same time it is also the most expensive and still very intransparent for sellers of products.

In the end, often several lines converge: on the one hand, internet users as potential buyers who are by now overwhelmed by irrelevant, unwanted advertising and find it unpleasant and no longer want to see it, and thus consciously or unconsciously ignore it, and on the other hand, advertisers, in particular specialized retailers, who want to reach the potential buyer group with their advertising and their products, but are confronted again and again with the problem that they reach their specialized target group only with difficulty without large-style scattering of advertisement with major advertising expenditure, and the risk that the addressed buyer group does not a fortiori block out the entire advertisement by means of advertising blockers etc. or unconsciously ignores it due to today's flood of advertising.

It is therefore the objective of the present invention to create a method for displaying advertisements whereby, on the one hand, the above-mentioned disadvantages, in particular the failure to reach the buyers in general or the relevant buyer group at the appropriate time in particular, respectively, and the lack of evaluability of the buyer data and advertising data, are avoided and, on the other hand, it is ensured cost-effectively and efficiently that the buyer perceives the advertisement as effectively and/or actively as possible and/or the seller or advertiser, respectively, receives evaluable and/or adjustable parameters for controlling the advertisement. Another objective is to simplify the operation of placing advertisements in electronic media.

The objective is achieved by the invention.

The invention relates to a method for displaying advertisements in a browser, in particular an “Encores browser”, in which a browser software or an app is installed on an electronic medium, in particular a computer, laptop, tablet or cellphone, and the browser is displayed on a screen when the software or app is activated, wherein searches are carried out via the browser on the internet or intranet for so-called contents, in particular keywords, headings, image descriptions, meta descriptions, IP addresses, etc., and the results are displayed or listed, respectively, in a display area of the browser, wherein a function bar with an input field, in particular for search words, links, IP addresses, etc., is displayed on the browser above the display area.

Here the method according to the present invention is characterized in that whenever a search query is started or a result is activated in the display area, or whenever an internet page is invoked directly by the browser, concomitantly a query is made in an advertising database for stored advertisements that are related to defined contents, whereby if an advertisement is stored and found, this advertisement is displayed in the browser independently of the Internet page invoked.

The advantage of this design is that user-specific advertisements can be placed regardless of which web page the Internet user or potential buyer, respectively, is on. This means that a large number of internet users are addressed directly in a separate area of the web browser with advertisements that are specifically of interest to them. For example, it is thus made possible that a user who is on a web page of the company “Mediamarkt” and is looking for a laptop is shown an advertisement of a laptop of the competitor “CD1”or “Conrad”, In contrast to the prior art, in which separate advertisements are displayed under each domain or on each website (such as Facebook, Amazon, Google, etc.), respectively, and can be called up there, according to the present invention it is now possible for the first time to display advertisements from third-party providers directly in the web browser in a separate area or image section, respectively, or frame. Web page owners, even including search engine providers such as Google or Bing, were previously able to place advertisements passively—i.e. the user or potential buyer, respectively, had to visit the web page—on their web page. Now, however, it is possible to provide the user or potential buyer, respectively, actively i.e. regardless of which web page he/she is on—with advertisements that are matched in particular to his/her user behavior. Thus, it can be said that one or several advertisements is/are displayed on a variety of found web pages, no matter which one the user opens, since the advertisement is connected to the browser, so to speak, and not, as from the state of the art, to the particular web page.

The state of the art in connection with the display of advertisements is that it is currently not possible to consume or display advertisements across domains and according to the specific wishes of the user. Currently, the internet user has no way to influence the advertisements displayed, but rather is forced to tolerate the advertisements displayed on his/her device.

Now the present technical innovation lies in the fact that the internet user can have advertising measures displayed on his/her device (whether cellphone, tablet, laptop or computer) in a domain-independent and targeted manner, as he/she can select relevant settings in the browser regarding the advertisements himself.

The advertiser can now address cross-domain advertising measures to internet users and is not limited to individual web pages or domains with his/her advertising, as it was previously the case. In order to achieve wide coverage, the advertiser had to place his/her advertisements on many different platforms, domains, web pages, which he/she can now do with a single placement on the browser. Thus, it is for the first time possible to display and serve the same advertisement in the browser, regardless of which web page or domain is currently being displayed or accessed.

Advantageous embodiments are also such where when an advertisement is found, an advertising area arranged on the side of the display area is expanded and one or several advertisements are loaded and displayed in the advertising area of the browser. This ensures that the advertising area does not need to be expanded all the time, but only when relevant advertisements are available for the internet user or potential buyer, respectively, these are displayed in a separate area or frame.

Unused screen space can thus be avoided. In addition, it is made possible to make specific settings on the user or provider side or on the buyer and seller side, respectively, e.g. at which time advertisements should be expanded or displayed in the browser, e.g. not during working hours, because the full screen space is needed here.

Advantageous embodiments are also such in which the advertisements are stored in relation to the previously used search terms, in particular keywords, the paid number of placements. the date, the visited web pages, etc. for retrieval on the advertising database. This ensures that the advertisements to be displayed can be optimally matched to the user behavior or user profile of the internet user or potential buyer, respectively, and to the desired seller profile or the invested advertising effort of the seller, respectively. For example, current search terms can be prioritized over those used a longer time before, so that users are primarily shown the advertisements that are currently relevant to them. At the same time, however, advertisements of sellers can be prioritized or ranked, respectively, among each other according to the advertising effort made by controlling the number of placements.

By means of an embodiment in which a button or a code for confirming the advertisement is arranged in the advertising area, it is advantageously achieved that it can be verified whether the internet user has seen the advertisement or not. This can be used to control further activities, such as a reward system running behind it.

The advantages of an embodiment in which the display area is adapted, in particular shrunk, when the advertising area is expanded are primarily that a separate advertising area can be displayed in addition to the display area, which still represents the visited web page, which in particular takes up a fixed size or size ratio of the screen or the original display area, respectively. Thus, the screen space is optimally utilized in that it can be used completely—if no advertisement is present—and is shrunk accordingly if an advertisement is present. At the same time, the user's attention is drawn more strongly to a new advertisement when it pops up.

Furthermore, in another advantageous embodiment a reward system is used in the browser for viewing advertisements, in which each user is credited with a corresponding contribution of the paid costs for this advertisement when specific advertisements are displayed. This ensures that the advertising, which is otherwise often perceived as annoying, is positively received by the user. In addition, it is achieved that the user perceives the advertising more consciously and/or not only sees displayed advertisements, but also clicks or invokes, respectively, linked advertisements, for example with a confirmation button.

It is also advantageous that a user account can be created in the browser and it can be selected which categories of advertisements the user would like to receive and/or not receive, as this allows the browser or the advertisement, respectively, to be adapted even more individually to the user. The user can also set the options for the web page he/she is on. For example, the user can specify that gambling content be not displayed in the advertising area and that pop-ups be suppressed on the web page on which the user is located. In combination with time settings, it is thus also possible, for example, to specify that educational content for children be displayed in the advertising area in the afternoon and unrestricted content in the evening.

By means of an embodiment in which a further display area for advertisements is arranged in the browser, in particular in the form of a longitudinal bar in the lower area, in which further advertisements, in particular so-called Impression Ads, are displayed, several, in particular different types of advertisements can be displayed in an advantageous manner. For example, concrete advertisements with images can be displayed in expandable fashion in the browser in the advertising area on the right-hand side of the screen, while links to advertisements are displayed in a comparatively narrow bar at the bottom of the screen.

Advantageous embodiments are also such in which the browser reads the keywords and/or the content on the pages on which a user is surfing and the appropriate advertisement is displayed regardless of which web page the user is on. This ensures that the advertisements displayed or appearing in the advertising area of the browser, respectively, can be controlled as precisely as possible according to the interests of the internet user. In this way, the user can also be shown products in the advertising area of the browser that the website operator does not have in his/her store, and the user also receives information about products and brands that he/she has not known before.

Advantageous embodiments are also such in which the browser reads user data, in particular the user's age, country region, language, and surfing behavior, and compares them with parameters or defaults, respectively, stored with the advertisements, and displays the advertisement in the browser if the user data matches the parameters or defaults, respectively. This results in even better adaptation and tuning of the placed advertisement to the user. For example, it is possible to prevent adult content from being displayed to underage persons, whereby country-specific laws (e.g., from when a young person is considered an adult) can also be taken into account with regard to the adjustable country region. Advertisements can also be controlled by displaying them at specific times of the day or according to seasonal criteria, etc. This enables very detailed control and matching between the advertiser's specifications and the user's settings, and can thus be used to address or reach, respectively, the relevant group of buyers even more specifically.

The invention further relates to a method for displaying advertisements in an app, in particular a browser app or Encores app, respectively, for electronic media, in particular tablets, cellphones, laptops or computers, in which a stored software is called upon activation.

The method according to the present invention is characterized in that other apps installed on the electronic medium or device, in particular their links or icons, are included or integrated, respectively, in the app. This means, for example, that other apps that are already installed on the cellphone and are therefore mainly used by the user, such as Facebook, Instagram, YouTube. etc., can be integrated into the browser or linked to it and opened. This allows the user, in particular when using a cellphone with a limited screen size, to open all installed apps via the Encores app, and he/she no longer has to flip back and forth between individual screens.

Advantageous embodiments are also such in which, when an app integrated or linked into the browser app or Encores app, respectively, is opened, the Encores app concomitantly queries an advertising database for stored advertisements that are related to defined criteria, in particular keywords, where, if an advertisement is stored and found, this advertisement is displayed on a separate display page of the Encores app that is opened. Inputs or keywords, respectively, that the user makes in apps that are integrated into or linked to the browser app are therefore read out and can be used to display user-specific advertising content or advertisements, respectively, in the browser app. For example, other apps, such as Facebook, eBay, YouTube, etc., can be loaded in the browser app, and a suitable advertisement can be displayed in the browser app based on the search terms used there, e.g. search eBay for model airplanes and display advertisements for model airplanes, drones and remote-controlled cars.

Finally, advantageous embodiments are also such where the advertisement can be displayed across domains and apps and domain-independent and dependent advertising in the browser. This enables an advertisement to reach a wide variety of devices, including cellphone, tablet, laptop and computer.

The invention will now be explained in more detail by reference to the exemplary embodiments illustrated in the drawings.

The figures show:

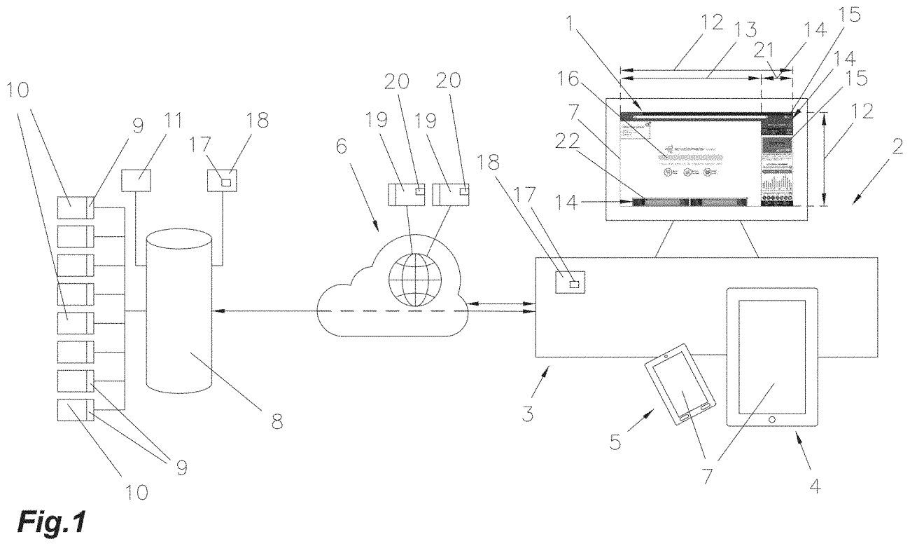

FIG. 1 a process diagram of a browser according to the present invention, in particular the “Encores browser” in connection with the internet and an advertising database, simplified, for illustrative purposes only;

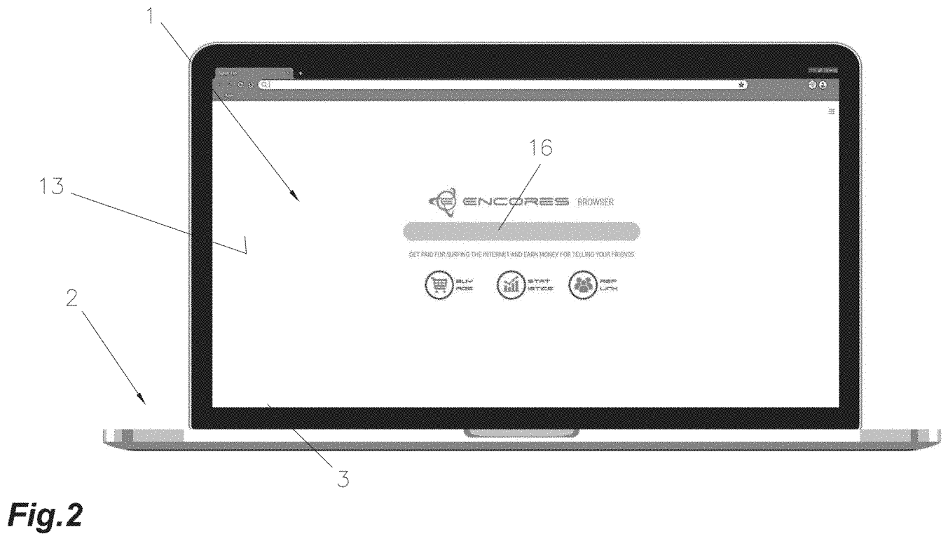

FIG. 2 a schematic representation of the browser on a laptop, simplified, for illustrative purposes only;

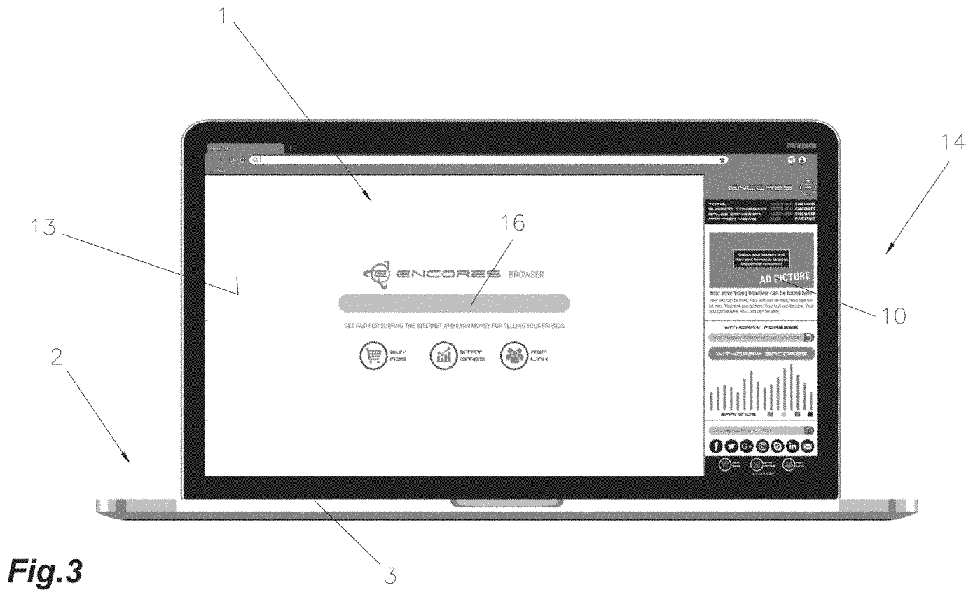

FIG. 3 a schematic representation of the browser according to FIG. 2 with the advertisement area open and an advertisement placed, simplified, for illustrative purposes only;

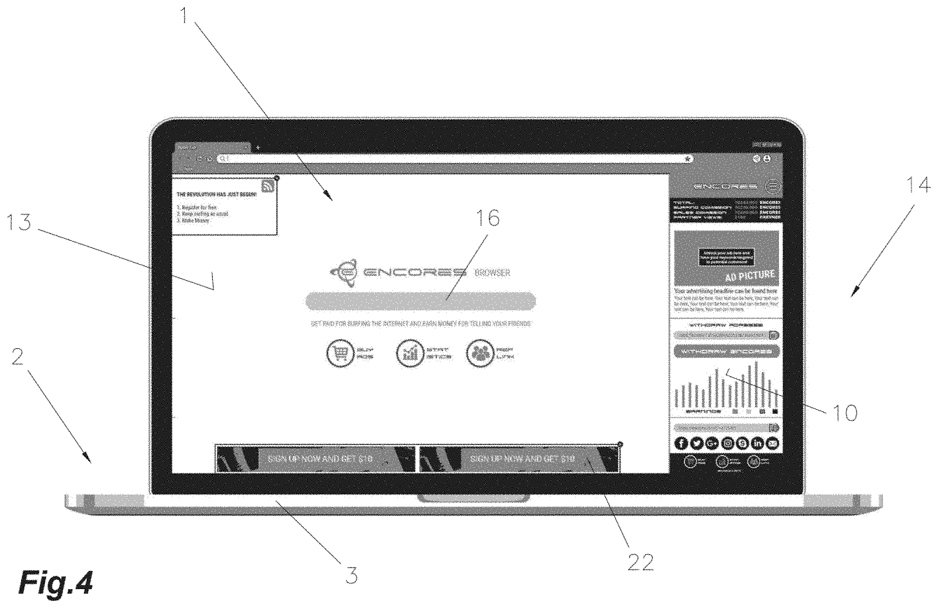

FIG. 4 a schematic representation of the browser according to FIG. 3 with a further advertising area, in particular arranged in the lower area, simplified, for illustrative purposes only;

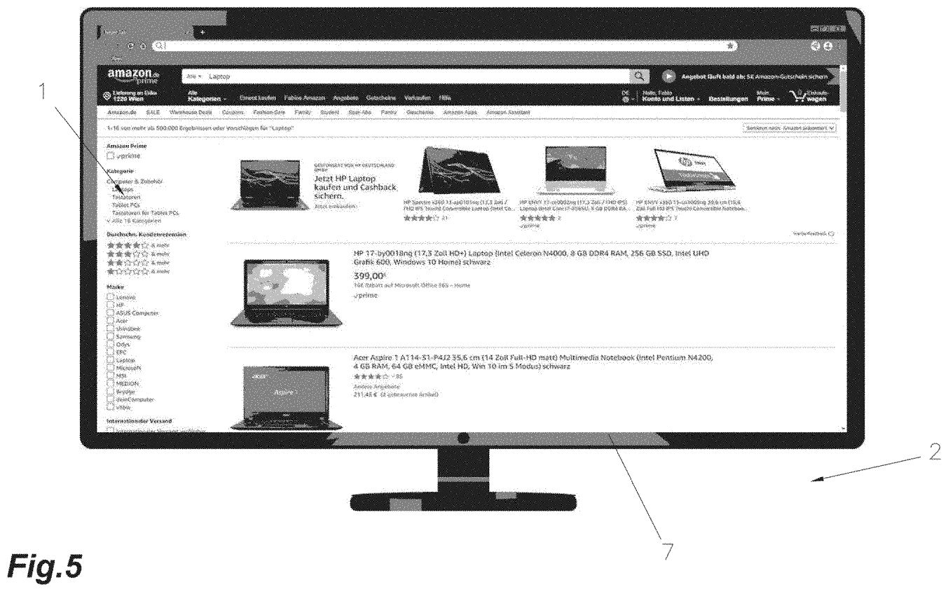

FIG. 5 a schematic representation of the browser on a computer, in particular screen of the computer, simplified, for illustrative purposes only;

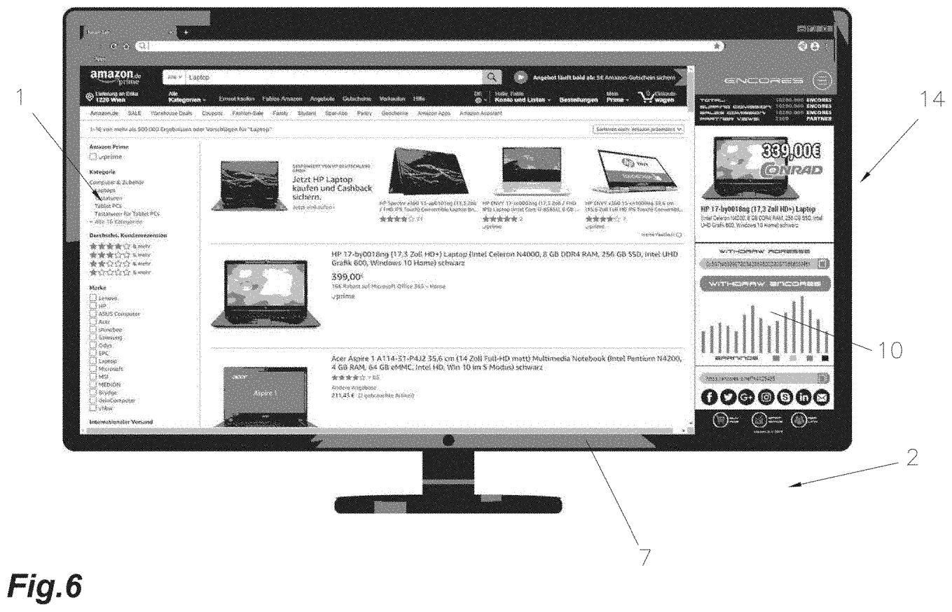

FIG. 6 a schematic representation of the browser according to FIG. 5 on a computer, in particular screen of the computer, with the advertisement area open and an advertisement placed, simplified, for illustrative purposes only;

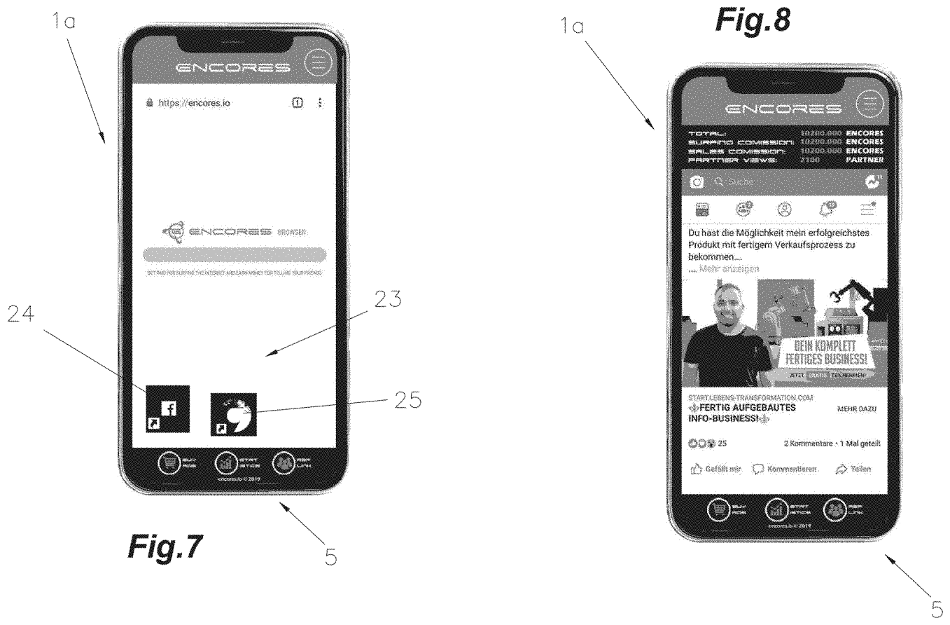

FIG. 7 a schematic representation of a browser app, in particular an “Encores app” on a cellphone, simplified, for illustrative purposes only;

FIG. 8 a schematic representation of the browser app according to FIG. 7 with the advertising area open, simplified, for illustrative purposes only;

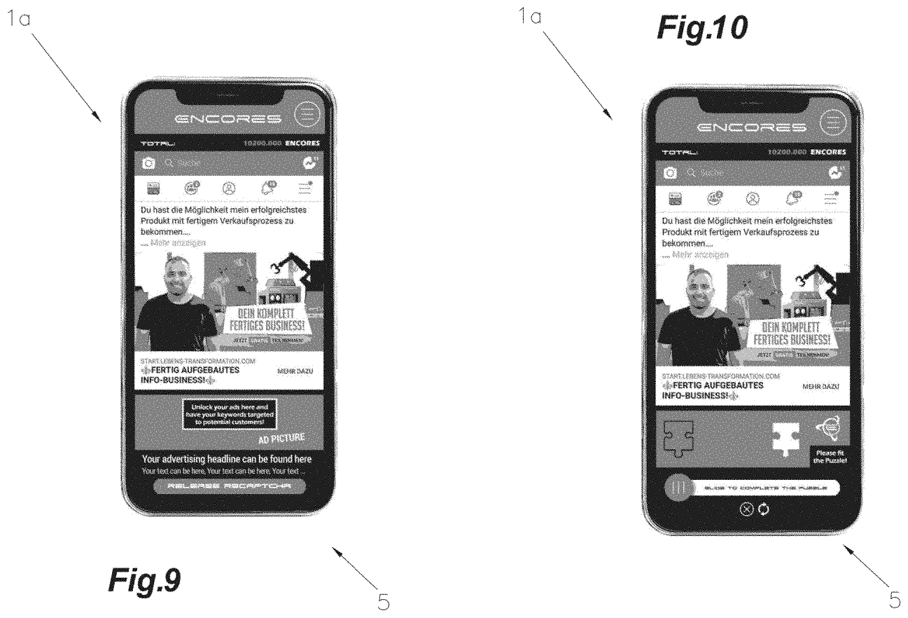

FIG. 9 a schematic representation of the browser app according to FIG. 8 with a confirmation button, simplified, for illustrative purposes only;

FIG. 10 a schematic representation of the browser app according to FIG. 8 with an activation activity, in particular a puzzle, simplified, for illustrative purposes only;

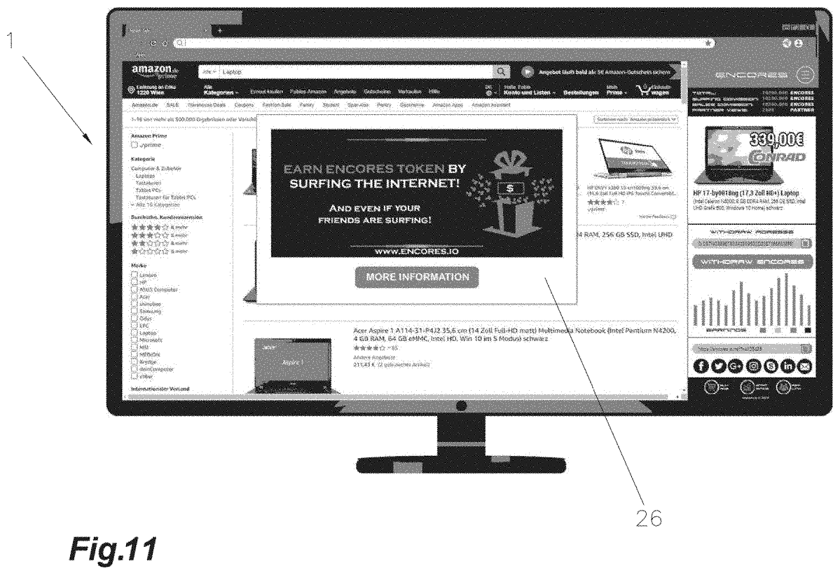

FIG. 11 a schematic representation of the browser with an open advertisement and a push message for another or the same advertisement, simplified, for illustrative purposes only;

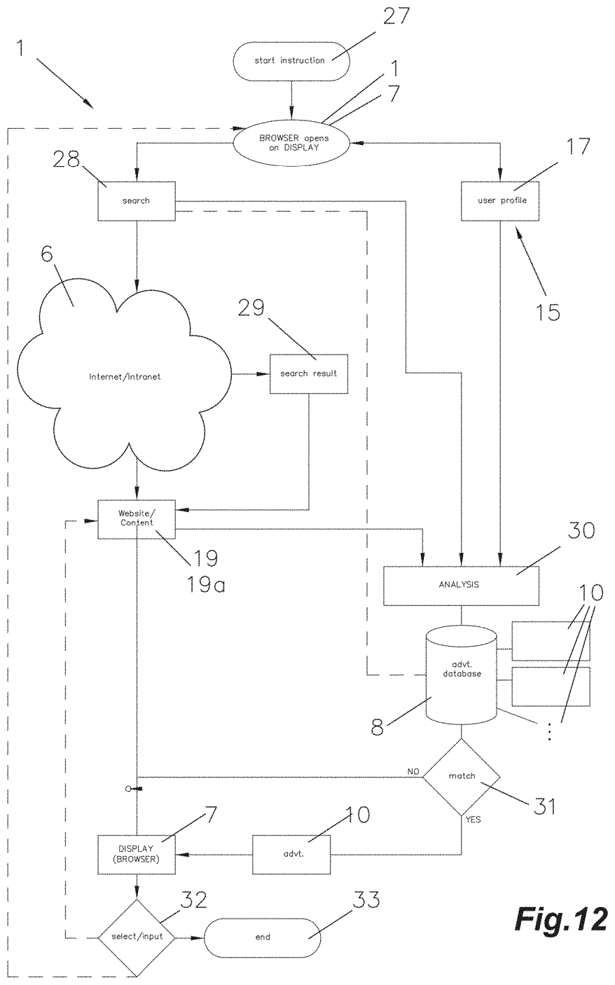

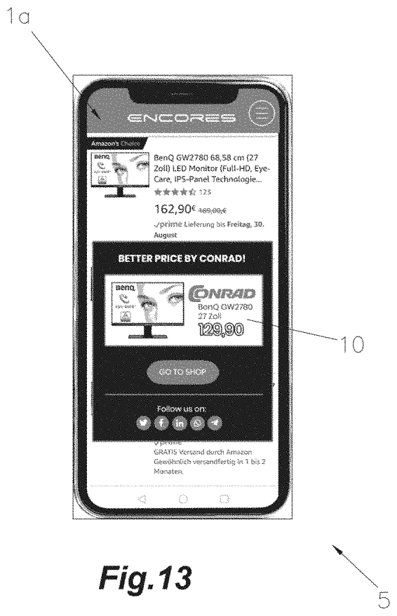

FIG. 12 an exemplary embodiment of process steps of the browser according to the present invention, in particular the “Encores browser”, in connection with the internet and an advertising database, simplified, for illustrative purposes only;

It should be stated by way of introduction that, in the individual embodiments, identical parts are provided with the same reference numbers or same component designations, respectively, wherein the disclosures contained in the entire description can, by analogy, be transferred to identical parts with identical reference numbers or identical component designations, respectively. The position details selected in the description, such as, e.g., top, bottom, lateral, etc., likewise relate to the figure described, and in the event of a change of position, they are to be transferred to the new position by analogy. Individual features or feature combinations from the exemplary embodiments shown and described may also represent independent inventive solutions.

In FIGS. 1 to 11, in particular in FIG. 1, a browser 1, in particular web browser 1 or “Encores” browser 1, is shown, which or whose browser software is installed on an electronic medium 2, in particular a desktop or laptop 3 or computer 3, tablet 4 or cellphone 5, respectively. The electronic medium 2 may be a local medium or an electronic medium 2 integrated into a network or internet and/or intranet, respectively, 6. Browser 1 is as a matter of principle understood to mean the user or operating interface, respectively, of the browser software, which is shown on a display 7, in particular of the electronic medium 2. In the same way, however, the browser 1 can also be understood to mean the browser software itself.

The browser 1 or the browser software, respectively, represents the user interface for web applications and is connected to the internet and/or intranet 6. In addition, the browser 1 or the browser software, respectively, is connected to a database 8, in particular an advertisement database 8, which is also connected to the Internet and/or intranet 6.

Media content or contents 9, respectively, preferably advertisements 10, is/are stored on the database 8, to each of which a wide variety of criteria 11 can be assigned, which are defined by the database operator and/or the advertiser. General criteria 11, which are preferably assigned to multiple advertisements 10, and/or specific criteria 11, which are preferably assigned to the individual advertisements 10, may be established. Such criteria 11 can be, for example, descriptors or keywords, respectively, headlines, image descriptions, meta descriptions, domain names, IP addresses, country criteria, age of the target group, times or points in time, etc.

The browser 1 or a display area 12 of the browser 1, respectively, which in full-screen mode corresponds to the display area of the display 7, has a display area 13 for displaying web content, in particular the web pages which the user is reading or on which the user is surfing, respectively, and one or several advertising areas 14, which can be permanently anchored in the browser 1 or can also be arranged so that they can be expanded and folded away or shown and hidden, respectively. Preferably, from the user's point of view, the advertising area 14 that is designed to be expanded and folded away or shown and hidden, respectively, is arranged in the right area of the browser 1, and the fixed advertising area 14 is arranged in the lower area of the browser 1. As described, a plurality of advertising areas 14 are preferably arranged, in each of which one or several of the advertisements 10 may be placed. In the same way, however, only a single advertising area 14 can be arranged or the display of the advertising areas 14 can be switched off completely.

The browser 1 can be customized for specific users. Via a preferences selection 15, in particular a selection list or selection button, such and further settings or parameters, respectively, regarding the user data and the advertising behavior of the browser 1 can be made or specified. In particular, parameters such as age, frequency and type of desired advertisements 10, areas of interest of the user, undesired advertising content, etc., can be specified. The user criteria defined in the preferences 15 either control the browser 1 or the operating or user interface, respectively, of the browser 1 itself and/or serve as additional information or parameters, respectively, to more specifically match advertising content or advertisements 10 to the user.

Concomitantly, additional data are read out and stored about the surfing behavior of the user of browser 1 or the user, respectively, such as descriptors or keywords used to search in a search field 16 in browser 1, headlines, image descriptions, meta descriptions, domain names and IP addresses of web pages searched for or visited in browser 1, country criteria, times or points in time relating to surfing behavior, web pages recently accessed and their content, etc.

Here all data collected, in particular those about the user's surfing behavior and/or the settings in the preferences 15, are stored in user profiles 17 so that they can be evaluated and/or compared with the criteria 11 of the provider, in particular the database operator and/or the advertiser and/or seller. Thus, advertisements 10 can be displayed or presented, respectively, in the advertising areas 14 that match the interests and current needs of the users as precisely as possible. Here, such user profiles 17 can be stored on a local and/or external storage system 18 or data carrier, respectively, in particular via network connections.

In contrast to the prior art, where advertising of the web page operator is displayed on a web page 19, e.g. company web pages 19 such as mercedes-benz.com, store web pages 19 such as amazon.com or search engine web pages 19 such as google.com or bing.com, it is now possible for the first time to display advertising directly in the browser 1 irrespective of which web page 19 the user is on, i.e. an independent advertisement is displayed in the browser, but the advertising linked to the web page 19 called up is also displayed.

The web page 19 which the user, in particular internet user, is reading or a content 19a of the web page 19, respectively, is thereby displayed in the display area 13. If no advertising area 14 is displayed, the display area 13 essentially corresponds to the display area 12. If an advertisement 10 is displayed, i.e. an advertising area 14 is displayed or faded in, respectively, the display area 13 is preferably adapted, in particular reduced in size.

In the advertising area 14, for the first time advertisements 10 completely detached from the website operator or companies or stores, respectively, can now be displayed directly in the browser 1. Furthermore, user data are collected in the browser 1, preferably partly automatically and partly by the user, and it is thereby made possible to control advertisements 10 across web pages. In particular, advertisements 20 on the web pages 19 displayed in the browser 1 can thus be suppressed or blocked, respectively, in the display area 13, and only relevant and desired advertising content or advertisements 10 can be displayed in the advertising area 14 in the browser 1 according to the settings in the user profile 17. Especially since the browser 1 preferably records not only the search terms but also the temporal course of the search queries, the target of the search query (domain, IP address, content 19a of the visited web page 19, etc.) and also personal data (e.g. age) and preferences (e.g. areas of interest, for example audio engineering) and stores them as parameters in the user profile 17, and these parameters are or can be assigned, respectively, by the advertiser or provider—i.e. in particular by the advertiser or provider of goods and services—also to the advertisement 10, an effective alignment is created between what is offered or advertised, respectively, and what the internet user wants to see or what interests him. The user thus sees advertising—regardless of which web page 19 he/she is reading or surfing on, respectively—specifically according to his/her interests, at times that suit him/her (e.g. after work) and without undesirable content (e.g. gambling).

Preferably, several advertising areas 14 and/or advertisements 10 can be displayed or shown simultaneously in the browser 1 or display area 12, respectively, for example in a screen section 21 indented from the edge of the display area 12 of the browser 1, in the form of an advertising bar 22 at the edge of the screen, as an advertising insertion, e.g. push notification, or login advertisement, i.e. as a large-area or full-area advertisement 10 when the browser 1 is opened or started, respectively. In the same way, advertising areas and/or advertisements 10 can be displayed only for a short time and then hidden again, or alternatively an action by the user can be required.

The preferred embodiment is such that an advertising area 14 is arranged at the right edge of the screen in the display area 12 of the browser 1, i.e. in particular in the screen section 21, which is separated horizontally from the display area 13. This advertising area 14 is preferably displayed or shown or unfolded, respectively, in the presence of a suitable advertisement, i.e. in particular an advertisement whose profile or parameters match the user profile or parameters of the user. Preferably, when the advertising area 14 is shown or expanded, respectively, the display area 13 for the web page 19 is shrunk accordingly. At the same time, the displayed web page 19 can also be reduced in size, or this can be retained in the original size, or this setting can be automated according to the visited web page 19. In combination with the fact that the position of the advertisement 10 or the advertising area 14 can also be specified, undesired content from specific or specified, respectively, web pages 19 can thus also be covered with the advertisement 10 or the advertising area 14.

In this advertising area 10, which is arranged in the right section of the display area 12, preferably advertisements 10 requiring more space, e.g. with images, and/or PPC advertisements, i.e. a so-called pay-per-click advertisement, can be displayed.

At the lower edge of the screen in the display area 12 of the browser 1, the advertising area 14 is preferably displayed in the form of the advertising bar 22, in which preferably alternating insertion of short advertisements 10 and/or scrolling texts and/or advertising links are displayed.

It should be noted here that all options of individual described advertisements 10 or advertising areas 14, such as the type of appearance on the screen, the time-controlled fading in and out or manual closing of an advertisement, etc., can also be transferred to other advertisements 10 or advertising areas 14, respectively. In the same way, it is of course possible that the displayed advertisements 10 or advertising areas 14, respectively, are dimensioned differently or open in the same web window, or alternatively in a new web window of the browser 1. It is also possible for advertisements 10 or advertising areas 14, respectively, to be freely positioned and sized in the display area 12 of the browser 1, whereby the position and size preferably are determined differently for different web pages 19.

In the advertising area 14, not only advertisements 10 can be displayed, but also other information, such as technical articles, trade fair information, tips and tricks, news feeds, etc., i.e. information for the user in his/her area of interest can also be displayed—similar to a magazine. Furthermore, brochures can be presented for download. Another possibility is that the user is provided with knowledge or learning content in the advertising area 14 in the form of training courses etc., e.g. including mathematics and reading exercises for children, or reminders and exercises in the user's area of interest, e.g. reminders to drink something, take a short exercise break, etc., for a fee or in exchange for purchased credit or free of charge, respectively. Furthermore, rankings, product reviews, product tests and the like can be integrated into the advertising area 14 and/or to the respective advertisement 10. These additional functions can be activated or deactivated, respectively, via the settings, in particular via the user profile.

It is also possible that goods and services displayed or advertised, respectively, in the advertising area 14 can be ordered and paid for directly via the browser 1. Preferably, the order is forwarded to the advertiser or seller, respectively, and the goods and/or services are shipped directly by the advertiser or seller in the background. In the same way, subscriptions can be offered and concluded.

Further, a reward system is preferably provided in the browser 1. In this context, the user or internet user, respectively, receives a reward or remuneration in the form of money and/or credit, in particular for each consciously perceived advertisement 10 and/or for each brochure downloaded, etc. Preferably, the user receives an amount or a share of the costs that the advertiser has paid for the placement of the advertisement 10. For example, an advertiser pays for a PPC advertisement, i.e., a pay-per-click advertisement, and pays a certain amount for each click on an advertisement 10, and each user who clicks on and/or confirms the advertisement 10 receives a certain amount or partial amount, respectively, thereof. Preferably, a separate code, in particular a so-called Captcha code, is provided for confirmation by the user. Entering the code ensures that the user has indeed seen the advertisement 10. Furthermore, it is possible that in addition to or instead of the code, a question regarding the content of the advertisement 10 is asked in order to ensure that the user has also read the advertisement 10, in particular by selecting the correct answer.

In sum, the advertisement 10, which is provided with criteria 11 that can preferably be set by the advertiser, is displayed to the user or internet user or surfer, respectively, if and when it meets the parameters in the user profile, i.e. the advertisement 10 is seen by the user who actually wants to see it and thus has set the corresponding parameters in his/her preferences 15 and preferably when the advertiser wants to show it to the user, whereby ultimately the user is rewarded for reading that advertisement 10 which also interests him/her, and the advertiser only pays when his/her advertisement 10 has actually been read by the desired target group.

The user's payment or reward, respectively, for having advertisements 10 displayed to him/her in the advertising area 14 can thereby be determined as a proportion of the advertising costs and/or per click and/or in the case of mere display as an Impression Ad, in the advertising area 14 or as a push notification or as a login advertisement. For the most part, different advertising areas 14 are arranged in the browser 1 and set with different options or reward models, respectively. It is up to the user to decide which advertising areas 14 or advertisements 10 he/she wants to see and/or when he/she wants to see them, and he/she is rewarded with credits the more advertisements 10 he/she allows to be displayed or confirms or actively perceives, respectively. Preferably, the user's current credit balance is displayed in the browser 1 and the user has the option of having this paid out and/or redeeming it, preferably by means of a voucher code, for purchases and/or for his/her own advertisements 10 in the browser 1.

It is also possible that, in the case of advertisements 10, it is specified as a criterion how frequently this is displayed to the user, i.e. whether the advertisement 10 is displayed to the same user only once or more frequently, in particular with parameters such as display frequency and/or period and/or time of day and/or intervals etc. of the advertisement 10 to the same user.

The advertiser, in turn, has the possibility to display evaluations and statistics, in particular about users reached and their age, country, directly made purchases, etc., and the success of different advertising strategies. Users or potential buyers, respectively, can thus be addressed effectively, whereby measurable success controls are arranged to enable ongoing improvement of the advertising measures. Furthermore, information mechanisms and/or warning mechanisms can be provided, in particular in an automated manner, which inform the advertiser about improvements of his/her advertising strategy and/or futile advertising strategies. For this purpose, for example, criteria or parameters or key figures, respectively, can be defined on the basis of which the advertiser receives corresponding information or warning messages, e.g. if not a single purchase was made in browser 1 for 1000 advertisements 10 confirmed by means of code. In this case, the advertiser specifies in the settings or criteria, respectively, 11 of the advertisement 10 metrics about whose fulfillment or non-fulfillment he/she would like to be informed, preferably electronically, e.g. by email or via his/her advertising account.

Such a targeted approach through advertisements 10 and evaluation was previously possible only via expensive advertising professionals, and by far not transparent to the same extent. In addition, the reward system makes it possible for the first time to convey a positive feeling with advertisements 10 and also to place advertisements 10 and perform evaluations across websites in a simple manner.

Specifically, FIGS. 2 through 11 show a wide variety of applications and display options for the Encores browser 1. Here, FIGS. 2 to 4 show the browser 1 on a laptop 3 after the Encores browser 1 has been opened, wherein FIG. 1 does not show any advertisements 10 yet and FIG. 3 shows the Encores browser 1 with the advertising area 14 expanded and the advertisement 10 displayed therein. In FIG. 4, an exemplary embodiment is shown with another advertising area in the form of an advertising line/advertising bar 22, which is usually displayed throughout the entire usage time of the Encores browser 1, but the advertisement shown therein changes automatically due to different settings. These advertisements in the advertising lines are preferably placed independently of the criteria and/or contents used or determined, respectively.

Furthermore, FIGS. 5 and 6 show a representation of the Encores browser 1 on a computer, in particular its display 7. Again, in FIG. 5, the Encores browser 1 is shown after the opening of the software or app, respectively, in which no advertisements 10 are displayed yet, whereas in FIG. 6, the advertising area 14 is shown with an advertisement 10 displayed therein. Another special feature of the illustration is that FIG. 5 shows the display page of “Amazon” with the search result for “laptops” as an example, and FIG. 6 shows an advertisement 10 of a competitor, for example the company “Conrad”, displayed to the user based on the latter's search for “laptops”. Thus, it can be seen that regardless of the web page accessed, which will usually want to display their own advertisements on their web page, competitor offers or advertisements, respectively, connected with the browser 1 are also displayed, The user thus enjoys the advantage that corresponding offers from other providers are also displayed to him/her and he/she can thus select the cheapest variant.

FIGS. 7 to 10 now show the Encores browser 1 in the form of an Encores app 1a on the cellphone 5. Here, it is apparent from FIG. 7 the Encores app 1a that icons 23 for apps installed on the cellphone 5, such as Facebook 24 or Chrome 25, etc., are integrated into the Encores app 1a, which can be opened via the Encores app 1a. For this, the user only has to click on the corresponding app, so that the corresponding app is opened automatically. FIG. 1 shows, for example, an advertisement 10 that is displayed on the full screen, whereby here alternatively only part of the cellphone display may be used.

Preferably, the displayed advertisements 10 in the individual figures are linked to corresponding web pages, so that by clicking on the advertisement, this advertising page is displayed in the display area 13 of the browser 1 or by another browser 1. As a matter of principle, it should be mentioned that the Encores browser 2 can be opened and operated several times in parallel on one medium. In FIG. 9, the advertisement 10 is provided with a confirmation booting or confirmation box, respectively, that the user must click on to receive a reward for viewing their advertisement 10. It is also possible to integrate other forms for the conscious perception of the advertisement 10, as shown in FIG. 10 by a puzzle that the user has to complete.

FIG. 11, on the other hand, shows an embodiment in which a so-called push message 26 is shown. This can be used instead of or in addition to the advertising area 13.

FIG. 12 shows an exemplary embodiment of a process flow of the browser 1 and/or the browser app 1a according to the present invention. In this case, the user of the browser 1 or of the browser app 1a, respectively, issues a start instruction 27, preferably by clicking on a start button or voice instruction, and the browser 1 is invoked or started, respectively, and shown or displayed on the display 7 of the electronic medium 2. The browser 1 is assigned the user profile 17, in which the user can set preferences 15 by preferably entering a wide variety of personal and/or user-specific and/or advertising-specific data or parameters, respectively. Thus, on the one hand, parameters can be selected or set, respectively, by the user in the user profile 17 and, on the other hand, search queries 28 can be carried out by the user, preferably in a search field 16 (not shown) provided for this purpose, on the internet and/or intranet 6. For example, the search query 28 may be done for domains, IP addresses, search terms or keywords, respectively, etc., and either web pages 19 with content 19a and/or search results 29 may be shown to the user in the display 7 of the browser 1. When a search result 29 is selected, the corresponding linked web page 19 is selected.

The data in the user profile 17 and/or search queries 28 and/or the web pages 19 and/or their content 19a, respectively, are evaluated by means of analysis 30. Thereby, the criteria 11 of the advertisements 10 linked to the database 8 are compared with results of the analysis 30 and, in case of a match 31 of the parameters of the analysis 30 or of the user profile 17, respectively, and/or entered search query 28 and/or of the displayed web page 19 or contents 19a, respectively, opened and/or displayed on the display 7 of the browser 1 with the criteria 11 of the advertisement 10, respectively.

In the event of a match or a hit of the advertisements 10 stored on the database 8 or their criteria 11, respectively, with the data or parameters of the user compiled in the analysis 30, in particular their default values and search behavior, the advertisements 10 are thus displayed in the browser 1. As already described, these are preferably displayed in a separate advertising area 14. However, it is also possible for the user to query or search directly in the database 8 or advertising database, respectively, for stored advertisements, as shown by the dashed lines in search query 28.

If several advertisements 10 or their criteria 11, respectively, match, the matching advertisements 10 can be displayed one after the other with a time delay. Preferably, the display frequency, duration and time of the advertisement depend on the invested advertising budget of the advertiser.

Finally, it is possible to decide in a selection 32 whether to terminate or close, respectively, the browser 1 by triggering an exit function 33 or, as shown in dashed lines, to call another web page 19 or sub-web page 19 or to start a new search query 28 or enter new keywords, respectively, and/or to change the settings 15 in the user profile 17. Preferably, as a result of all changes, whether person-related or in the search behavior, in particular clicking on or entering other web pages 19 or domains, entering new or further keywords in the search queries 28, changes to parameters in the user profile 17, etc., the analyses 30 or the checking of the parameters or criteria 11 of the advertisements 10 for correspondence with the information or parameters obtained from the search queries 28, user profile 17 and web pages 19 called up or content 19a displayed there are carried out anew and advertisements 10 output or displayed on the display 7 of the browser 1 or the browser app 1a, respectively.

Preferably, the browser 1 or the browser app 1a, respectively, may be provided with a remembering or learning function. This can be achieved in particular by storing the various entries in the search field 16 or the search queries 28, respectively, and/or the settings 15 or parameters in the user profile 17, respectively, and/or the web pages 19 called up or their content 19a, respectively, over time. These can thus be used for intelligent evaluation or extended criteria 11 of the advertisements 10 or extended parameter input by the advertiser, respectively. In the same way, it can be used to identify and evaluate user behavior patterns.

It is pointed out that the invention is not limited to the embodiments shown, but may comprise further embodiments. In particular, the embodiments or individual features of the embodiments can also be combined with each other.

1. A method for displaying advertisements in a browser, in particular an “Encores browser”, in which a software or app of the browser is installed preferably on an electronic medium, in particular a computer, laptop, tablet or cellphone, and the browser is displayed on a screen or display, respectively, when the software or app is activated, whereby the browser is used to search the internet and/or intranet for so-called content, in particular keywords, headlines, image descriptions, meta descriptions, IP addresses, etc., and the results are displayed or listed, respectively, in a display area of the browser, wherein a function bar with an input field, in particular for search words, links, IP addresses, etc., is displayed on the browser above the display area wherein when a search query is started or a result activated in the display area or when an internet page is invoked directly by the browser, concomitantly a database, in particular an advertising database, is queried for stored advertisements which are related to defined criteria and/or the content, wherein, if a stored advertisement is found, this advertisement is displayed in the browser independently of or as a function of the internet page or web page, respectively, invoked.

2. The method according to claim 1, wherein when an advertisement is found, an advertising area arranged laterally to the display area is expanded and one or several advertisements are loaded and displayed in the advertising area of the browser.

3. The method according to claim 1, wherein the advertisements are stored for retrieval in the database or advertising database, respectively, in relation to the previously used search terms, in particular keywords, the paid-for number of placements, the date, the visited interne or web pages, etc.

4. The method according to claim 1, wherein a button or a code for confirming the advertisement is provided in the advertising area.

5. The method according to claim 1, wherein the display area is adapted, in particular shrunk, when the advertising area is expanded.

6. The method according to claim 1, wherein a reward system for viewing advertisements is used in the browser, in which each user is credited with a corresponding contribution of the paid costs for this advertisement, respectively, when specific advertisements or advertisements are displayed.

7. The method according to claim 1, wherein a user account can be created in the browser and via preferences the categories of advertisements the user wants to receive and/or not receive can be selected.

8. The method according to claim 1, wherein a further advertising area for advertisements is arranged in the browser, in particular in the form of a longitudinal bar in the lower area, in which further advertisements, in particular so-called impression advertisements, are displayed.

9. The method according to claim 1, wherein the browser reads out the keywords and/or the content on the web pages on which a user is surfing and the matching advertisement is displayed independently of or as a function of which web page one is on.

10. The method according to claim 1, wherein the browser reads user data of the user, in particular the user's age, country region, language, surfing behavior, then stores or saves these, respectively, in user profiles and compares them with parameters or criteria stored with the advertisements and, if the parameters or user data in the user profile match the parameters or criteria respectively, of the advertisement, displays the advertisement in the browser.

11. A method for displaying advertisements in an app, in particular a browser app or Encores app, respectively, for electronic media, in particular tablets), cellphones, laptops or computers, in which a stored software is invoked upon activation, wherein other apps installed on the electronic medium or device, respectively, in particular their link or icons, respectively, are drawn into or included in the app.

12. The method according to claim 11, wherein when an app integrated or linked, respectively, into the browser app or Encores app respectively, is opened, the Encores app concomitantly queries an advertising database for stored advertisements which are related to defined criteria, in particular keywords, where, if an advertisement is stored and found, this advertisement is displayed on a separate display page of the Encores app which is opened.

13. The method according to claim 11, wherein the advertisement can be displayed across domains and apps, and in domain-independent and dependent fashion advertisements can be shown in the browser.
